(19) United States
(12) Patent Application Publication
(10) Pub. No.: US 2004/0128242 A1
(43) Pub. Date: Jul. 1, 2004

(54) Application-of-reservation management method, program and system

(75) Inventors: Seiji Morita, Kawasaki (JP); Kuniaki Yamada, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/730,103

(22) Filed: Dec. 9, 2003

(30) Foreign Application Priority Data
Dec. 9, 2002 (JP) 2002-356275

(51) Int. Cl. G06F 17/60

(52) U.S. Cl. 705/39; 705/5

(57) ABSTRACT

An acceptance processing unit accepts an application-of-reservation of a tour including application fee payment information and fee direct debit request information. If no application of cancellation is accepted during cancellation periods set in a plurality of stages taking as reference the tour starting date, then a charge processing unit calculates the tour charge direct debit amount based on a cancellation fee rate previously defined for each cancellation period and requests a financial institution to make a direct debit from the applicant's account. If an application of cancellation is accepted during any one of the cancellation periods defined in plural stages taking as reference the tour starting date, then a cancellation fee processing unit calculates a cancellation fee based on the previously defined cancellation fee rate and requests the financial institution to make a direct debit from the applicant's account.

### BACKGROUND OF THE INVENTION

1. Field of the Invention

The present invention relates generally to an application-of-reservation method, program and apparatus for automatically withdrawing a charge for a tour from an applicant's account based on a tour contract concluded as a result of an application of reservation, and more particularly to an application-of-reservation method, program and apparatus in which the charge for the tour is divided for a direct debit into a plurality of times until the execution of the tour.

2. Description of the Related Art

Up until now, on acceptance of applications of reservation of tours from users, travel agencies typically charge the users for application fees, and when tour contracts are concluded as a result of receipt of payment of the application fees, they begin to arrange for the tours reserved on the basis of the tour contracts concluded.

The applicants are also asked for the payment of the balance, the amount that remains after the application fee is deducted from the charge for the tour by a specified due date, which is set to e.g., 21 days prior to the day before the date when the tour starts.

For this reason, the users have to pay the balance in cash or on credit at the store by the specified due date or alternatively have to transfer the charges for tours into predetermined accounts specified by the travel agencies. The tour charges paid by the users may amount to a large sum of money in case of, e.g., overseas cruising tours using deluxe passenger liners. Thus, in view of the safety of both the users and the agencies, it is rather desirable to use the transfer into the accounts than the cash payment.

The payment may naturally be made with credit cards although the credit cards have respective use limits and cannot be used for the payments of the tour charges exceeding the use limits.

A conventional way to pay the tour charges via accounts is to transfer the tour charges into the agencies' accounts by the users having completed the transfer procedures, but a future way may be to withdraw the tour charges from the accounts specified by the users.

On the contrary, the arrangements for the tours are made prior to the dates when the tours start, and hence the users are charged for the cancellation fees arising from the users' cancellations from e.g., 30 days before the tour starting date. These cancellation fees are defined such that the rates of the cancellation fees are increased accordingly as the date of cancellation is closer to the tour starting date with the remaining period before the tour starting date being divided into a plurality of stages.

In the case where the cancellation fees occur in this manner, the application fees have already been paid upon the applications of reservation and the balances have been paid by 21 days prior to the day before the tour starting date. Therefore, when cancellations occur, the travel agencies have to refund to the users the differences which remain after the cancellation fees are deducted from the tour charges received.

[Patent Document 1]

Japanese Patent Application Laid-open No. 1999-328272

[Patent Document 2]

Japanese Patent Application Laid-open No. 2002-197226

In such a conventional tour charge payment method, however, when cancellations occur under the circumstances where payments of the users are delayed for some reasons, if the cancellation fees cannot be compensated for by the application fees only, the users may newly be charged for the shortages of the cancellation fees, whereupon the travel agencies may possibly fail to fully collect the cancellation fees.

When viewed from the users on the contrary, the users have to pay the full amount of the tour charges rather before the tour starting date. This means that in case for example the users attempt to allot for the payment fixed deposits which will expire immediately before the tour starting date, the users have to withdraw money from the fixed deposit accounts half way through and will fail to receive the interest expected.

Furthermore, since the users cannot have enough time to prepare the tour charges, the payment of the tour charges may become overdue if the users are in financial troubles. In this case, contact must be made with the travel agencies to inform them that the payment is delayed, to secure the reservation, which can not inconveniently cope with the financial circumstances variations.

### SUMMARY OF THE INVENTION

The present invention was conceived in view of the above problems. It is therefore the object of the present invention to provide an application-of-reservation management method ensuring that the travel agencies do not fail to collect cancellation fees and that the users enjoy deferring the payment until the day as closer to the tour starting date as possible.

In order to achieve the above object, according to a first aspect of the present invention there is provided an application-of-reservation management method comprising:

an application acceptance step accepting by an application accepting unit tour application-of-reservation information which includes application fee payment information and charge direct debit request information; and

a charge processing step calculating by a charge processing unit a tour charge direct debit amount based on a cancellation fee rate previously defined for each cancellation period if no application of cancellation is accepted during cancellation periods set in a plurality of stages taking as reference the tour starting date, and requesting a financial institution to make a direct debit of the tour charge direct debit amount from the applicant's account.

Thus, the present invention enables the user to enjoy deferring the payment until a fixed date as closer to the tour starting date as possible and having enough time to prepare the payment of the charge for the tour, during which the user can benefit in terms of interest through operations of user's assets.

The application-of-reservation management method of the present invention further comprises a cancellation fee processing step calculating by a cancellation fee processing unit a cancellation fee based on the previously defined cancellation fee rate if an application of cancellation is accepted during any one of the cancellation periods set in a plurality of stages taking as reference the tour starting date, and requesting the financial institution to make a direct debit of the cancellation fee from the applicant's account.

Thus, according to the present invention, when the user's cancellation is confirmed by the travel agency on the last day of any one period of the cancellation periods set in a plurality of stages, the travel agency can automatically withdraw from the user's account the amount that remains after the received application fee is deducted from a cancellation fee so that it can securely receive the cancellation fee without failing to collect the cancellation fee in case the user has made a cancellation.

Herein, the charge processing step comprises:

a first charge processing step, on three days prior to the day before the tour starting date, calculating a first direct debit amount that remains after the application fee is deducted from 20% of the tour charge, and requesting the financial institution to make a direct debit of the cancellation fee;

a second charge processing step, on the day before the tour starting date, calculating a second direct debit amount that remains after the application fee and the first direct debit amount are deducted from 30% of the tour charge, and requesting the financial institution to make a direct debit of the cancellation fee;

a third charge processing step, on that day of the tour starting date, calculating a third direct debit amount that remains after the application fee, the first direct debit amount and the second direct debit amount are deducted from 50% of the tour charge, and requesting the financial institution to make a direct debit of the cancellation fee; and

a fourth charge processing step, when the participation has been established after the start of the tour, calculating a fourth direct debit amount that remains after the application fee, the first direct debit amount, the second direct debit amount and the third direct debit amount are deducted from the tour charge, and requesting the financial institution to make a direct debit of the cancellation fee.

In a case where a family of four have applied a reservation of a tour which costs ¥250,000 per person for example, the application fee totals ¥200,000 for ¥50,000 per person, the balance ¥800,000 of the tour charge is divisionally automatically withdrawn from the applicant's account by ¥100,000 on the day before the tour starting day, by ¥200,000 on that day, and by ¥500,000 when the participation in the tour has been established. For this reason, the users have only to prepare the balance ¥800,000 of the tour charge by three days before the tour starting date at the latest.

The cancellation fee processing step comprises for each applicant:

a first cancellation processing step, when an application of cancellation has been accepted during a period from thirty days prior to the day before the tour starting date to three days before the tour starting date, calculating a cancellation fee that remains after the application fee is deducted from any one of ¥50,000 for the tour charge of ¥300,000 or more, ¥30,000 for the tour charge of ¥150,000 or more and less than ¥300,000, ¥20,000 for the tour charge of ¥100,000 or more and less than ¥150,000 and 20% of the tour charge for the tour charge of less than ¥100,000, and requesting the financial institution to make a direct debit of the cancellation fee;

a second cancellation processing step, when an application of cancellation has been accepted on two days before the tour starting date and on the day before the tour starting date, calculating a cancellation fee that remains after the application fee is deducted from 30% of the tour charge, and requesting the financial institution to make a direct debit of the cancellation fee;

a third cancellation processing step, when an application of cancellation has been accepted on that day of the tour staring date, calculating a cancellation fee that remains after the application fee is deducted from 50% of the tour charge, and requesting the financial institution to make a direct debit of the cancellation fee; and

a fourth cancellation processing step, when a participant has not appeared on the tour starting date without a contact or when an application of cancellation has bee accepted after the start of the tour, calculating a cancellation fee that remains after the application fee is deducted from 100% of the tour charge, and requesting the financial institution to make a direct debit of the cancellation fee.

In a case where an application of reservation of a tour which costs ¥250,000 per person has been accepted for a family of four, the cancellation fee is ¥200,000 at 20% rate when the application of cancellation is made by three days before the tour starting date, which can be cancelled out by the application fee. The cancellation fee is ¥300,000 at 30% rate when the application of cancellation is made by the day before the tour starting date, whereupon the shortage ¥100,000 that remains after the application fee ¥200,000 is deducted from the cancellation fee is automatically withdrawn from the user's account.

The cancellation fee is ¥500,000 at 50% rate when the application of cancellation is made on that day of the tour starting date, whereupon the shortage ¥300,000 that remains after the application fee ¥200,000 is deducted from the cancellation fee is automatically withdrawn from the user's account. When a participant has not appeared on the tour starting date without a contact or when an application of cancellation has been accepted after the start of the tour, the cancellation fee is ¥1,000,000 at 100% rate, with the result that the shortage ¥800,000 that remains after the application fee ¥200,000 is deducted from the cancellation fee is automatically withdrawn from the user's account.

The cancellation fee processing step further comprises a peak cancellation processing step, when the tour starting date is at the peak and when an application of cancellation has been accepted during a period from 40 days prior to the day before the tour starting date to 31 days prior to the day before the tour starting date, calculating a cancellation fee that remains after the application fee is deducted from 20% of the tour charge with the cancellation fee's upper limit set to ¥50.000, the peck cancellation processing step, if the cancellation fee is positive, requesting the financial institution to make a direct debit of the cancellation fee, and if the cancellation fee is negative, requesting the financial institution to pay the shortage into the travel agency's account.

In a case where an application of reservation of a tour which costs ¥250,000 per person has been accepted for a family of four at its tour starting date being at the peak, the cancellation fee is ¥100,000 at 10% rate when the application of the cancellation has been accepted during a period from 40 days prior to the day before the tour starting date to 31 days prior to the day before the tour starting date, which can be cancelled out by the application fee, with the remainder of the application fee being paid to the use's account.

As used herein, the peak refers to periods from December 20 to January 7, from April 27 to May 6, and from July 20 to August 31.

In order to attain the above object, according to a second aspect of the present invention there is provided a program executed by a computer such as a travel agency's server for payment of charges, the program allowing the computer to execute:

an application acceptance step accepting tour application-of-reservation information which includes application fee payment information and charge direct debit request information; and

a charge processing step calculating a tour charge direct debit amount based on a cancellation fee rate previously defined for each cancellation period if no application of cancellation is accepted during cancellation periods set in a plurality of stages taking as reference the tour starting date, and requesting a financial institution to make a direct debit of the tour charge direct debit amount from the applicant's account.

The program of the present invention allows the computer to further execute a cancellation fee processing step calculating a cancellation fee based on the previously defined cancellation fee rate if an application of cancellation is accepted during any one of the cancellation periods set in a plurality of stages taking as reference the tour starting date, and requesting the financial institution to make a direct debit of the cancellation fee from the applicant's account. The details of this program are substantially the same as those of the application-of-reservation management method.

In order to attain the above object, according to a third aspect of the present invention there is provided an application-of-reservation managing apparatus comprising an application accepting unit accepting tour application-of-reservation information which includes application fee payment information and charge direct debit request information; and a charge processing unit calculating a tour charge direct debit amount based on a cancellation fee rate previously defined for each cancellation period if no application of cancellation is accepted during cancellation periods set in a plurality of stages taking as reference the tour starting date, and requesting a financial institution to make a direct debit of the tour charge direct debit amount from the applicant's account.

The application-of-reservation managing apparatus of the present invention further comprises a cancellation fee processing unit calculating a cancellation fee based on the previously defined cancellation fee rate if an application of cancellation is accepted during any one of the cancellation periods set in a plurality of stages taking as reference the tour starting date, and requesting the financial institution to make a direct debit of the cancellation fee from the applicant's account. The details of this application-of-reservation managing apparatus are substantially the same as those of the application-of-reservation management method.

In order to attain the above object, according to a fourth aspect of the present invention there is provided an application-of-reservation management method which is applicable to any application of reservation without being limited to the charges for tours, the method comprising:

an application acceptance step accepting by an application accepting unit an application-of-reservation which includes payment of an application fee and a request for direct debit of a charge from the applicant's account; and

a charge processing step calculating by a charge processing unit a charge direct debit amount based on a cancellation fee rate previously defined for each cancellation period if no application of cancellation is accepted during cancellation periods set in a plurality of stages taking as reference the execution date of the reservation applied, and requesting a financial institution to make a direct debit of the charge direct debit amount from the applicant's account.

This method further comprises a cancellation fee processing step calculating by a cancellation fee processing unit a cancellation fee based on the previously defined cancellation fee rate if an application of cancellation is accepted during any one of the cancellation periods set in a plurality of stages taking as reference the execution date of the reservation applied, and requesting the financial institution to make a direct debit of the cancellation fee from the applicant's account.

The above and other objects, aspects, features and advantages of the present invention will become more apparent from the following detailed description when taken in conjunction with the accompanying drawings.

### BRIEF DESCRIPTION OF THE DRAWINGS

FIG. 1 is a block diagram of the functional configuration of a travel agency server processing application-of-reservation management according to the present invention;

FIG. 2 is an explanatory diagram of a computer hardware environment to which is applied the travel agency server of FIG. 1;

FIG. 3 is an explanatory diagram of a tour contract database of FIG. 1;

FIG. 4 is an explanatory diagram of a application-of-reservation database of FIG. 1;

FIG. 5 is an explanatory diagram of an application-of-reservation screen;

FIGS. 6A and 6B are explanatory diagrams of an acceptance report screen;

FIGS. 7A and 7D are flowcharts of application-of-reservation management processing of the present invention; and

FIG. 8A and 8B are flowcharts of application-of-reservation management processing of the present invention including cancellation processing when the tour starting date is at the peak.

### DESCRIPTION OF THE PREFERRED EMBODIMENTS

An application-of-reservation management of the present invention intended for tours is implemented in the form of processing functions of a travel agency server 10. A bank server 12 is connected via a leased line network 16 to the travel agency server 10. User equipment 14 is also connected via an internet 18 to the travel agency server 10, the user equipment 14 capable of being connected via the internet 18 to the bank server 12 as well.

A travel agency having the travel agency server 10 sponsors various tours and users desiring to participate in the tours sponsored by this travel agency may go directly to the agency to make an application of reservation of a desired tour or may use a web page application-of-reservation screen by opening the web page provided by the travel agency server 10 through e.g., a WWW client of the user equipment 14.

The ordinary applications for tours by the users necessitate applications by entering necessary items in a written application of reservation required by the travel agency as well as typically payment of predetermined application fees. Furthermore, in the application-of-reservation management method of the present invention, when applying reservations of tours, the users submit written requests for direct debit of the tour charges from the users' bank accounts, and after the tour contracts have been concluded based on the applications of reservations, the travel agency server 10 can request of bank server 12 the direct debit of the tour charges from the users' bank accounts.

That is, the users perform for the applications of reservation to the travel agency:

(1) submission of written applications of reservation (including via the internet);

(2) payment of the application fees; and

(3) submission of written requests for direct debit. Among them, the written requests for direct debit have only to be submitted upon the first applications of reservation of the users, and the users need not again submit the written requests for direct debit upon the second or subsequent applications of reservation until the once submitted written requests for direct debit have been expired.

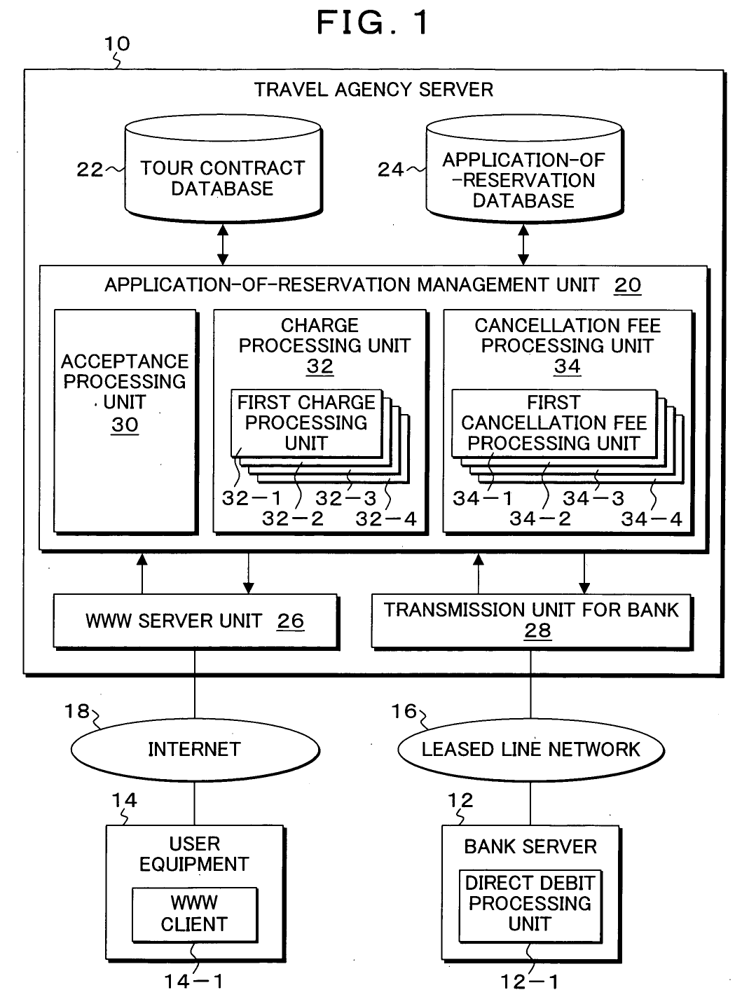

FIG. 1 is a block diagram showing the functional configuration of the travel agency server 10 together with the bank server 12 and the user equipment 14. The travel agency server 10 is provided with an application-of-reservation management unit 20, a tour contract database 22, an application-of-reservation database 24, a WWW server unit 26 and a transmission unit 28 for bank.

The application-of-reservation management unit 20 is provided with an acceptance processing unit 30, a charge processing unit 32 and a cancellation fee processing unit 34. The acceptance processing unit 30 accepts an application of reservation including application fee payment information and charge direct debit written request submission information.

In a case where no application of cancellation has been made during cancellation periods set in a plurality of stages taking as reference the tour starting date of a tour whose application-of reservation has been accepted, the charge processing unit 32 figures out a direct debit amount on the basis of a previously defined cancellation fee rate at the time of ending of each cancellation period, and requests the bank server 12 to execute a direct debit from the applied user's account.

In this embodiment, the charge processing unit 32 is provided with a first charge processing unit 32-1, a second charge processing unit 32-2, a third charge processing unit 32-3 and a fourth charge processing unit 32-4, which as will become apparent from the description later, request the bank server 12 to execute a direct debit of the tour charge in four installments so as to correspond to the cancellation periods set in four stages taking as reference the tour starting date.

In a case where an application of cancellation has been made during any one of the cancellation periods set in a plurality of stages taking as reference the tour starting date, the cancellation fee processing unit 34 figures out a cancellation fee on the basis of the previously defined cancellation fee rate, and requests of the bank server 12 a direct debit from the account of the user who has applied the reservation.

In this manner, the present invention is based on that the direct debit is carried out in installations for the tour charge on the basis of the stepwise cancellation fee rates of the tour whose application of reservation has been accepted, whereby it is ensured that the user enjoys deferring the payment until the day as closer to the tour starting date as possible and that the travel agency does not fail to collect cancellation fees even though the travel agency does not receive the charge for the tour in advance.

Corresponding to such a function of the travel agency server 10, the user equipment 14 is provided with a WWW client 14-1 which enables the user to read a web page for application of reservation of a tour provided by the travel agency server 10 via the internet 18 to thereby make an application of reservation of the tour over the internet.

The bank server 12 is provided with a direct debit processing unit 12-1. Since the user submits a written request for direct debit to a financial institution having the user's bank account when the user applies the reservation of a tour, the travel agency sends the written request for direct debit to the financial institution having the user's account.

Upon receipt of this written request for direct debit, the financial institution sets into the direct debit processing unit 12-1 conditions required for the direct debit processing so as to allow the direct debit processing for the direct debit request from the travel agency, such that when accepting the direct debit request thereafter from the travel agency server 10, the financial institution executes the direct debit of the requested charge from the user's account on a fixed date requested.

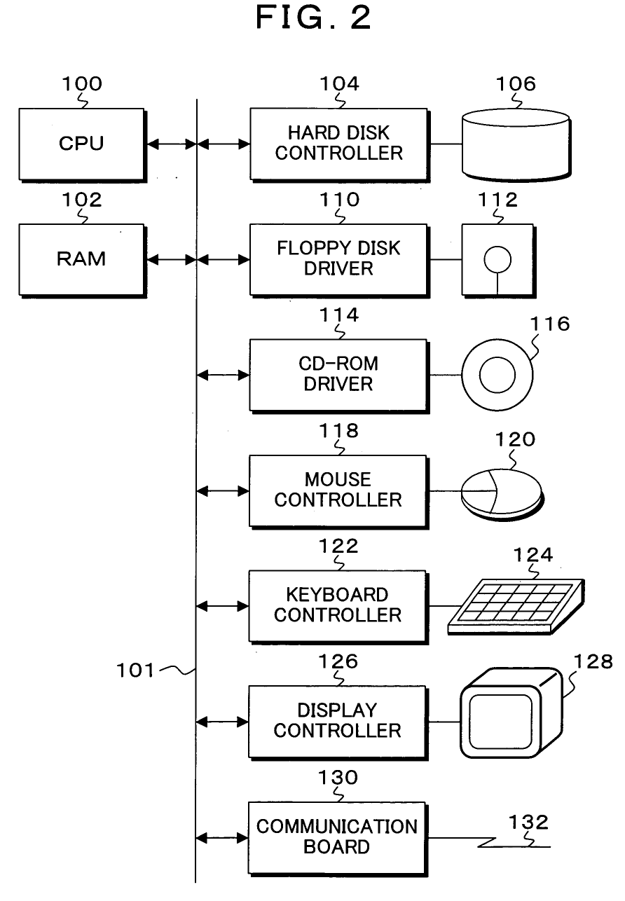

The travel agency server 10 of the present invention in FIG. 1 is implemented by hardware resources of a computer as shown in FIG. 2 for example.

In the computer of FIG. 2, a bus 101 of the CPU 100 is associated with a RAM 102, a hard disk controller (software) 104, a floppy disk driver (software) 110, a CD-ROM driver (software) 114, a mouse controller 118, a keyboard controller 122, a display controller 126 and a communication board 130.

The hard disk controller 104 connects to a hard disk drive 106 which is loaded with an application program for executing the tour application-of-reservation management processing of the present invention, and which calls a necessary program from the hard disk drive 106 upon the activation of the computer and deploys them on the RAM 102 for execution by the CPU 100.

The floppy disk driver 110 connects to a floppy disk drive (hardware) 112 which enables read and write to be effected on a floppy disk (R). A CD drive (hardware) 116 is connected to the CD-ROM driver 114 so that data or programs stored in a CD can be read.

The mouse controller 118 serves to transmit input operations of a mouse 120 to the CPU 100. The keyboard controller 122 acts to transmit input operations of a keyboard 124 to the CPU 100. The display control 126 provides a display for a display unit 128. The communication board 130 uses a communication line 132 including radio so as to make a communication via a network such as the internet with other computers or servers.

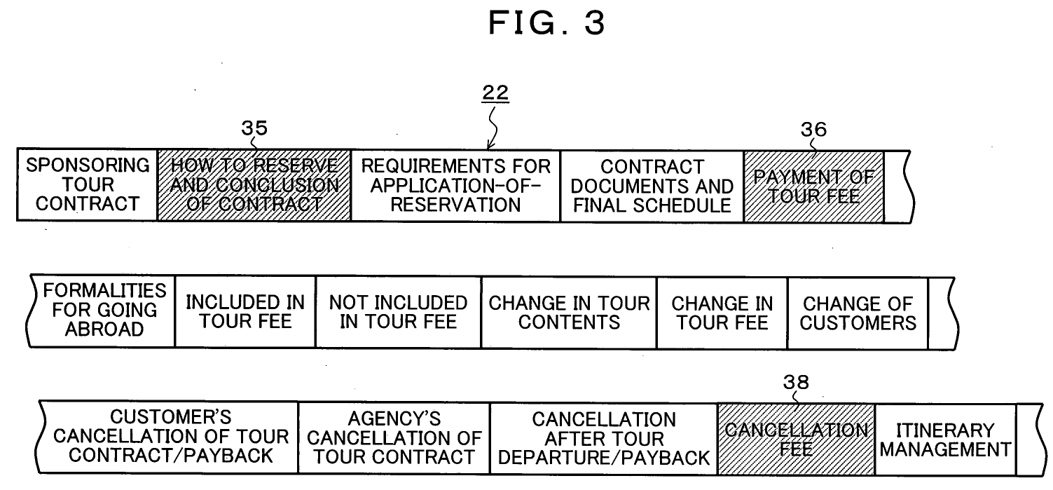

FIG. 3 is an explanatory diagram of a tour contract database 22 provided in the travel agency server 10 of FIG. 1. The tour contract database 22 includes an article “written sponsoring tour conditions” registered in advance thereon, defined previously in conformity to the legal rules.

The contents of the “written sponsoring tour conditions” registered in the tour contract database 22 include contents previously defining, e.g., how to apply for reservation of the sponsoring tour and conclusion of contract, requirements for application of reservation, contract documents and final schedules.

Among them, information on the direct debit of the tour charge of the present invention is the second “how-to-reserve and conclusion of contract 35, and the fifth “payment of tour charge 36” and the fifteenth “cancellation fee 38”.

“How-to-reserve and conclusion of contract 35” prescribes that a tour contract is concluded when a user enters into predetermined items on an application form and applies with a predetermined application fee or a full tour charge. The application fee upon this application of tour is as follows per applicant:

(1) application fee of ¥50,000 for the tour charge of ¥300,000 or more;

(2) application fee of ¥30,000 for the tour charge of ¥150,000 or more and less than ¥300,000; and

(3) application fee of ¥20,000 for the tour charge of less than ¥150,000.

“Payment of tour charge 36” defines the date of payment of the balance of the tour charge. The balance of this tour charge is prescribed to be paid, e.g., before 21 days prior to the day before the tour starting date.

In the application-of-reservation management processing of the present invention, however, the user requests the bank to make a direct debit of the tour charge upon the application of reservation of the tour, and hence it is prescribed that the user requested for the direct debit is not subjected to application of any fixed date for the payment of the balance of the tour charge but is subjected to execution of the direct debit in conformity to the direct debit contract.

The part of “cancellation fee 38” defines the cancellation fee in the case where the tour is cancelled for use's reasons after the conclusion of the tour contract. This cancellation fee is prescribed per applicant as follows:

(1) where the application of cancellation has been made during the period from 30 days prior to the day before the tour starting date to three (3) day prior to the day before the tour starting date,

(a) the cancellation fee is ¥50,000 for the tour charge of ¥300,000 or more;

(b) the cancellation fee is ¥30,000 for the tour charge of ¥150,000 or more and less than ¥300,000;

(c) the cancellation fee is ¥20,000 for the tour charge of ¥100,000 or more and less than ¥150,000; and

(d) the cancellation fee is 20% of the tour charge for the tour charge of less than ¥100,000;

(2) where the application of cancellation has been made on two days before and the day before the tour starting date, the cancellation fee is 30% of the tour charge;

(3) where the application of cancellation has been made on that day of the tour starting date, the cancellation fee is 50% of the tour charge; and

(4) where the applicant has not appeared on the tour starting date without any contact or the application of cancellation has been made after the start of the tour, the cancellation fee is 100% of the tour charge.

Furthermore, “cancellation fee 38” defines the cancellation fees corresponding to the peak in addition to the above (3) and (4) in the case of a tour whose tour starting date is at the peak. That is, in the case where the tour has its tour starting date at the peak and where the cancellation is made during a period from 40 days prior to the day before the tour starting date to 31 days prior to the day before the tour starting date, the cancellation fee is set to 10% of the tour charge with its upper limit being ¥50,000.

As used herein, the peak means periods from December 20 to January 7, from April 27 to May 6 and from July 20 to August 31.

On the basis of such the cancellation periods and cancellation fee rates of the “cancellation fee 38”, the present invention defines as follows the treatment of each user with respect to the direct debit of the tour charge in the “payment of the tour charge 36”:

(1) A first direct debit amount is automatically withdrawn from the user's account that remains after the application fee is deducted from 20% of the tour charge on three days prior to the day before the tour starting date;

(2) A second direct debit amount is automatically withdrawn from the user's account that remains after the application fee and the first direct debit amount are deducted from 30% of the tour charge on the day before the tour starting date;

(3) A third direct debit amount is automatically withdrawn from the user's account that remains after the application fee, and the first and the second direct debit amounts are deducted from 50% of the tour charge on that day of the tour starting date; and

(4) A fourth direct debit amount is automatically withdrawn from the user's account that remains after the application fee and the first to third direct debit amounts are deducted from the full tour charge when the participation of the user has been established after the start of the tour.

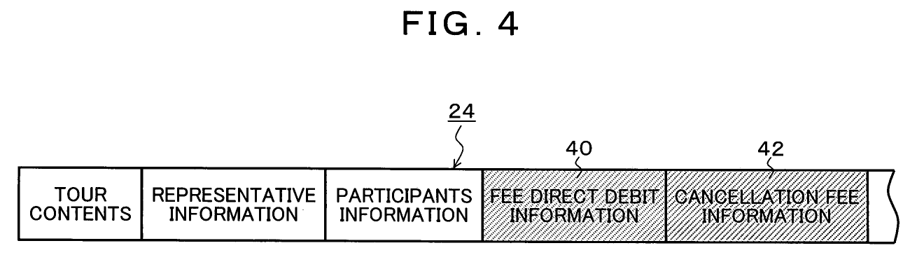

FIG. 4 is an explanatory diagram of the application-of-reservation database 24 provided in the travel agency server 10 of FIG. 1. This application-of-reservation database 24 includes the tour contents, representative information, participants information as well as the charge direct debit information 40 and the cancellation fee information 42.

The charge direct debit information 40 has therein registered the first to fourth direct debit amounts figured out, in addition to the user's direct debit account information. The cancellation fee information 42 has therein registered a cancellation fee figured out depending on the rate defined for each of the cancellation periods in plural stages up to the tour starting date, and a cancellation fee direct debit amount that remains after the application fee is deducted from the cancellation fee.

It is natural that if the amount is positive that remains after the application fee is deducted from the cancellation fee, then a surplus occurs and hence the surplus will be transferred into the user's bank account for refund.

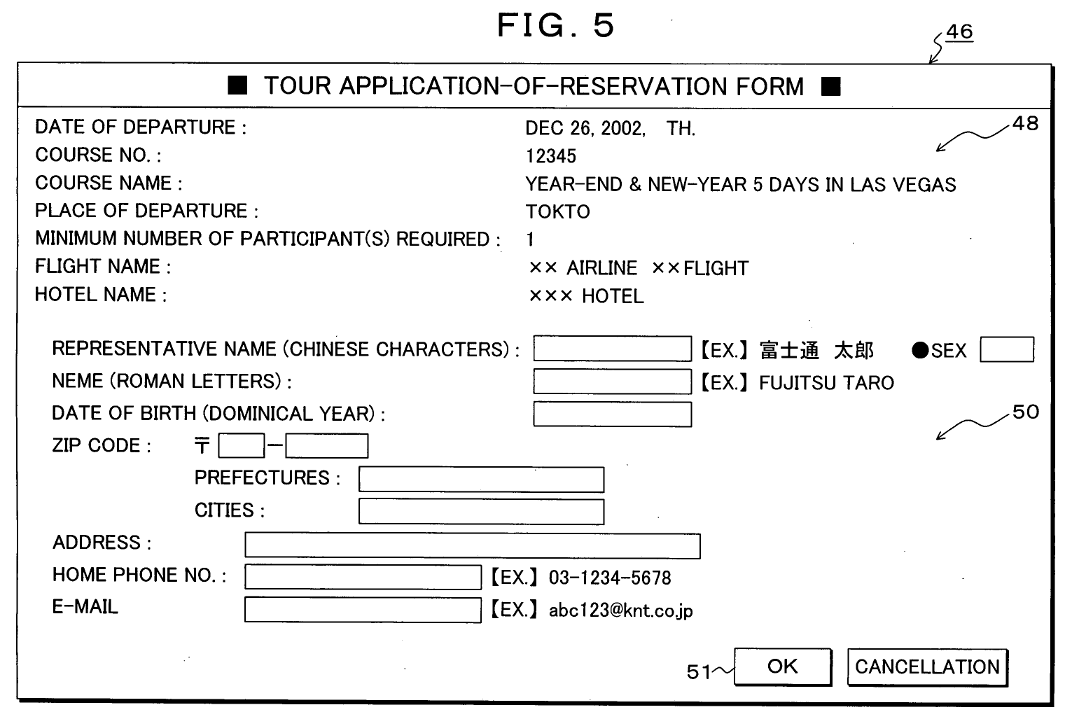

FIG. 5 is an explanatory diagram of an application-of-reservation screen 46 for making an application of reservation via the internet 18 to the travel agency server 10 of FIG. 1 using the WWW client 14-1 of the user equipment 14 for example.

The application-of-reservation screen 46 includes tour contents 48 and an application entry part 50. The tour contents 48 specify the contents of a tour which include the tour starting date and the course name. The user making an application of reservation of the tour has only to press an OK button 51 after entering the necessary items into the frames of the application entry part 50.

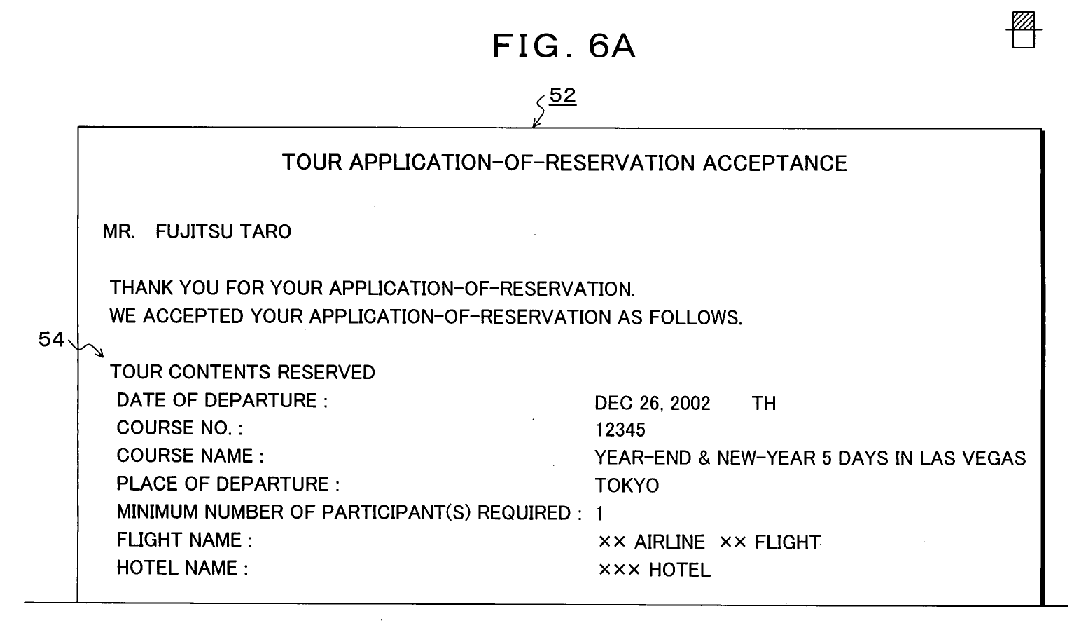

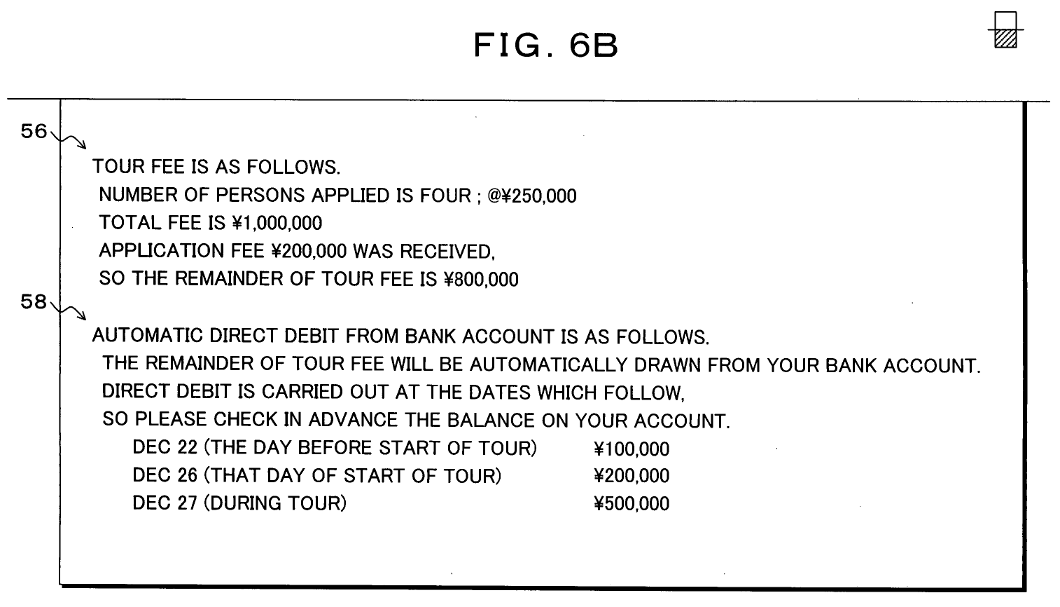

FIGS. 6A and 6B are explanatory diagrams of an acceptance report screen 52 issued from the travel agency server 10 in response to the application of reservation of the tour using the application-of-reservation screen 46 as shown in FIG. 5. The acceptance report screen 52 is titled “Tour Application-of-Reservation Acceptance” and includes items such as tour contents 54, tour charge 56 and direct debit schedule 58.

In the tour contents 54, for example, the total tour charge is ¥1,000,000 since the number of persons applied is four at ¥250,000 per person as in the tour charge 56. Because the application fee ¥200,000 has already been received, the balance of the tour chare is ¥800,000. Then, the tour charge balance ¥800,000 is scheduled to be automatically withdrawn from the user's financial institution account in three installations, i.e., in this example on the day before the tour starting date, that day of the tour starting date and the period during which the tour is held, as in the direct debit schedule 58.

For this reason user has only to prepare in the user's direct debit account ¥100,000 by two days before the tour starting date at the latest, ¥200,000 by the day before the tour starting date, and ¥500,000 by that day of the tour starting date. This can been seen that the tour charge balance payment conditions for the user are remarkably relaxed as compared with the fixed date of the conventional tour charge balance payment method in which the balance has been prescribed to be paid by 21 days prior to the day before the tour starting date, which has been defined in the case of direct debit.

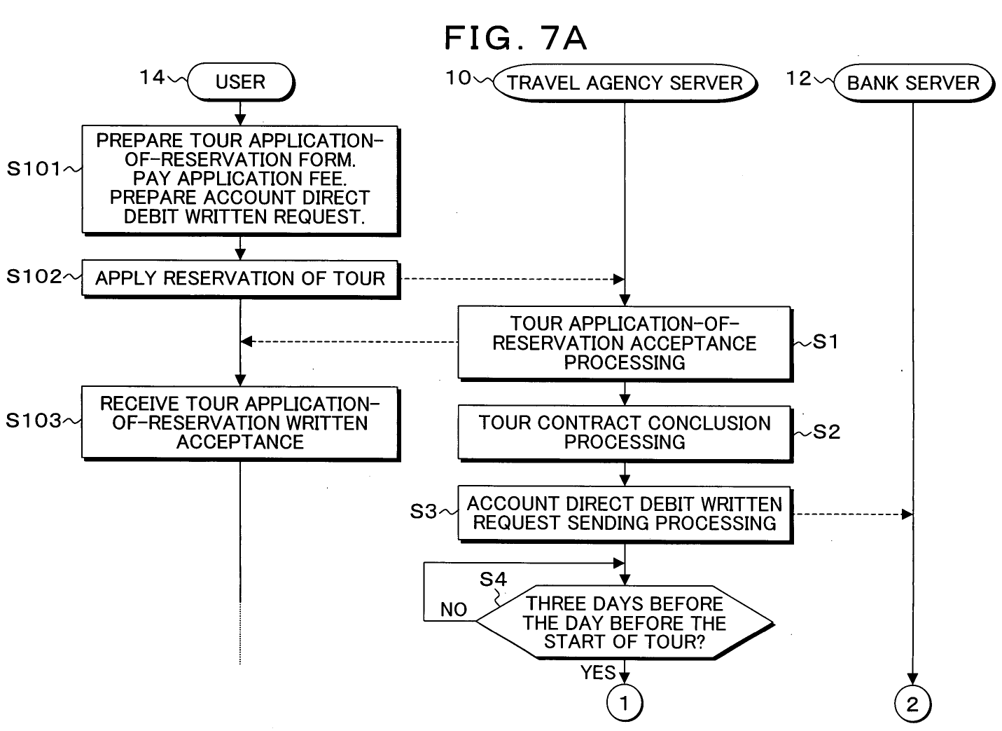

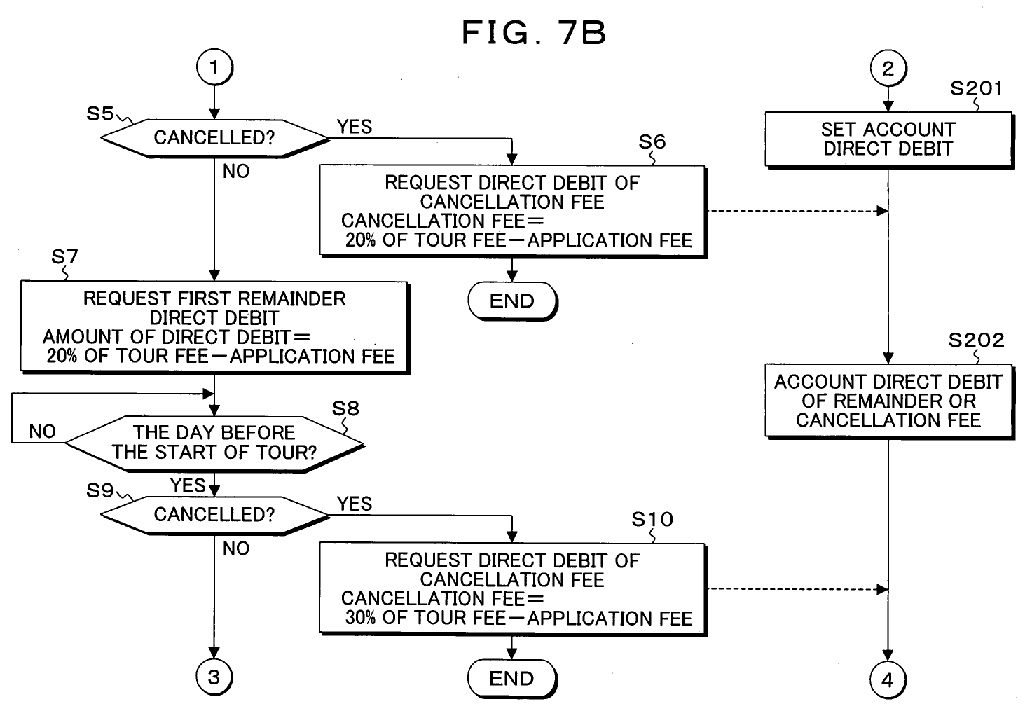

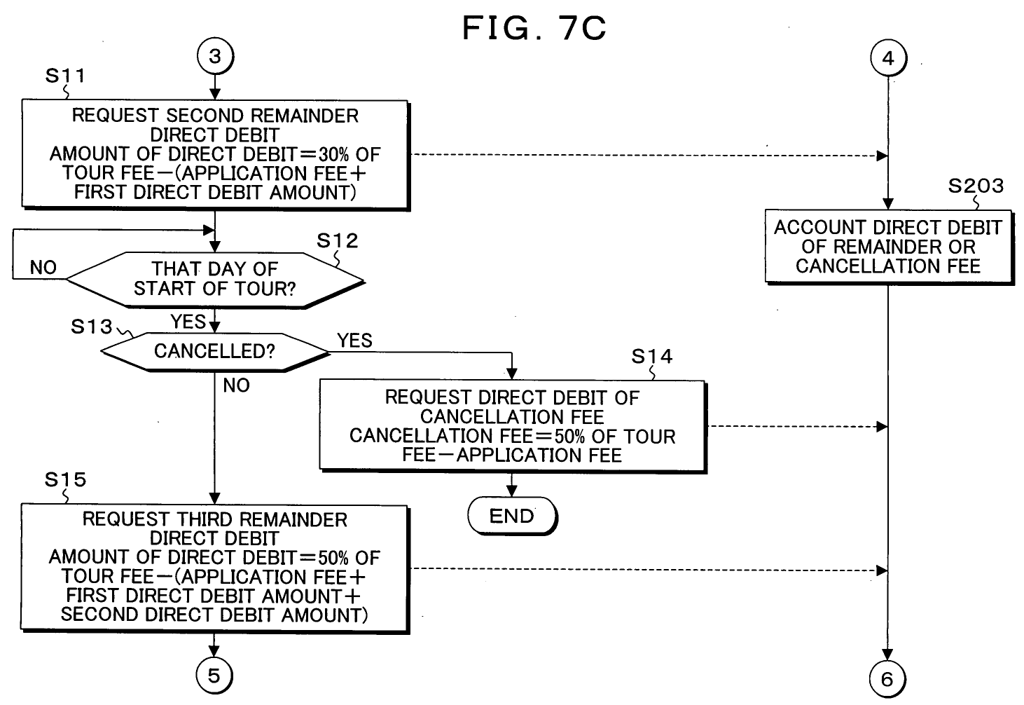

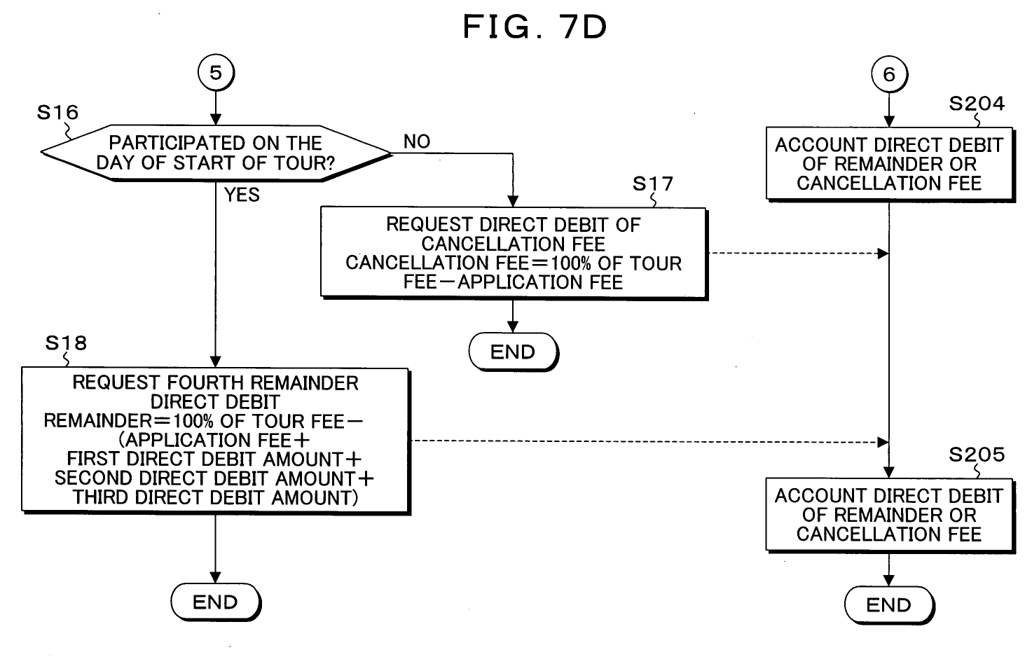

FIGS. 7A to 7D are flowcharts showing the procedure effected by the application-of-reservation management unit 20 provided in the travel agency server 10 of FIG. 1, and simultaneously showing the exchanges between the user equipment 14 and the bank server 12.

In FIGS. 7A to 7D, the user equipment 14 creates a tour application-of-reservation form as shown in FIG. 5 at step S101, and thereafter pays the application fee and creates an account direct debit written request which is prepared in advance.

When an application of reservation of a tour is then made at step S102, information is sent via the internet 18 to the travel agency server 10 which conforms to the entered contents of the application entry part 50 on the application-of-reservation screen 46 shown in FIG. 5, to perform the acceptance processing of the application of reservation of the tour at step S1.

In this case, since the payment of the application fee and the entry of the account direct debit written request are performed through user' s handworks, the acceptance processing of the application of reservation of the tour is performed at step S1 in the form of input information through the keyboard, etc. , into the travel agency server 10 based on receipt of the application fee by the person in charge of the travel agency and on the receipt of the account direct debit written request.

When the tour application-of-reservation information is received at step S1 which includes the application fee payment information and the account direct debit written request reception information, the tour contract conclusion processing is carried out of the reserved tour applied at step S2, and the result is posted on the user equipment, to perform the receipt of the tour application acceptance at step S103.

The tour application-of-reservation acceptance has the contents as shown in the acceptance report screen 52 of FIGS. 6A and 6B for example. Naturally, if the user does not use the user equipment 14, then the travel agency server 10 prints out the contents of the acceptance report screen 52 as shown in FIGS. 6A and 6B to directly pass it to the user or to send it to the user later.

Then at step S3, the travel agency server 10 performs the account direct debit written request sending processing for the bank server 12. This account direct debit written request sending processing may be effected on the bank server 12 on-line through the leased line network 16 or by sending by mail to the bank the bank's sheet of the account direct debit written request including a plurality of sheets of paper laid one on top of another which are capable of being copied by handwriting.

When the bank server 12 receives directly the account direct debit written request from the travel agency server 10 or the travel agency in this manner, the bank server 12 performs the setting of conditions for the account direct debit in conformity with the contents of request at step S201.

Thus, when an account direct debit request is issued from the travel agency server 10, the tour charge requested can automatically be withdrawn from the user's account at a fixed date. The processings of the steps S1 to S3 in the travel agency server 10 result in the processing functions of the acceptance processing unit of FIG. 1.

Then, the travel agency server 10 makes a check to see if a fixed date has been reached which is three (3) days prior to the day before the tour starting date. If this fixed date is reached, then the travel agency server 10 checks at step S5 whether an application of cancellation has been made from the user so far. If negative, then the procedure goes to step S7 to request the bank sever 12 to make the first balance direct debit.

The direct debit amount of the first balance direct debit request is an amount that remains after the application fee is deducted from 20% of the tour charge. The bank server 12 requested for the first balance direct debit at step S7 makes a direct debit of the balance at step S202 on a direct debit fixed date requested.

In response to this direct debit request, the bank server 12 makes a direct debit on the next day for the direct debit request for the previous day. In this example, since the first balance direct debit request is made on three (3) days prior to the day before the tour starting date, the direct debit of the balance at step S202 is carried out on the day corresponding to two days prior to the day before the tour starting date.

It is to be noted that if the day corresponding to thee days prior to the day before the tour starting date is Saturday, Sunday or National Holiday, then the first balance direct debit is requested of the bank server 12 at step S201 with its due date being the first weekday before the holiday. In this case, the direct debit of the balance at step S202 is performed on the first weekday after the request date.

Taking as example the tour charge 56 of the acceptance report screen 52 of FIGS. 6A and 6B, the amount of the first balance direct debit request at step S7 is ¥200,000 for four persons each costing ¥50,000 which is 20% of the full tour charge. However, since the application fee ¥200,000 is already received, the direct debit amount is 0 yen in this case and hence the first balance direct debit request is not performed due to no direct debit amount.

On the contrary, if the application of cancellation has been made from the user by three (3) days prior to the day before the tour starting date, then the procedure goes to step S6 to request the bank server 12 to make a direct debit of the cancellation fee.

The cancellation fee in this case is 20% of the tour charge and the balance of the cancellation fee is obtained by deducting the application fee from the cancellation fee, and the bank server 12 is requested for the direct debit of the balance so that the direct debit of the cancellation fee is carried out at step S202 on the next day.

Taking as example the application of reservation of FIGS. 6A and 6B, the cancellation fee in this case is ¥120,000 in total for four persons each being charged with cancellation fee of ¥30,000 since the tour charge per person is ¥250,000. Accordingly, when the application fee ¥200,000 is deducted from the total cancellation fee, ¥80,000 is left. For this reason, in the cancellation fee direct debit request at step S6, the bank server 12 is requested for the transfer of the refund of ¥80,000 into the user's account in order to refund to the user the balance that remains after the application fee is deducted from the cancellation fee.

When the first balance direct debit request is made at step S7, the travel agency server 10 goes to step S8 to check whether the fixed date, the day before the tour starting date is reached or not. When the day before the tour starting date is reached, it is checked at step S9 that the application of cancellation has been accepted or not, and if negative, the procedure goes to step S11, to perform the second balance direct debit request. In this case, the bank server 12 is requested for the direct debit of the amount that remains after the application fee and the first direct debit amount are deducted from 30% of the tour charge.

In the example of the application of reservation of FIGS. 6A and 6B, 30% of the tour charge per person is ¥75,000 totaling to ¥300,000 for four persons. When the application fee ¥200,000 and the first direct debit amount of 0 yen in this case are deducted from the cancellation fee of ¥300,000, the direct debit amount of the second balance direct debit request is ¥100,000, of which direct debit is requested of the bank server 12. For this reason, on that day of the tour starting date which is the next day, the bank server 12 executes at step S203 the direct debit of the tour charge balance of ¥100,000 requested from the travel agency server 10.

On the contrary, if the application of cancellation is issued from the user by the day before the tour starting date at step S9, then the bank server 12 is requested for the cancellation fee direct debit at step S10. The cancellation fee in this case is 30% of the tour charge and the amount that remains after the application fee is deducted from the cancellation fee is requested of the bank server 12 as the cancellation fee direct debit. In the case of the application of reservation of FIGS. 6A and 6B, the cancellation fee per person is ¥75,000 which is 30% of the tour charge, totaling to ¥300,000 for four persons. When the application fee ¥200,000 is deducted from the total cancellation fee of ¥300,000, ¥100,000 remains as the cancellation fee balance. Thus, the travel agency server 10 requests the bank server 12 to execute a direct debit of the cancellation fee balance of ¥100,000 so that the direct debit of the cancellation fee balance of ¥100,000 is carried out on the next day at step S203.

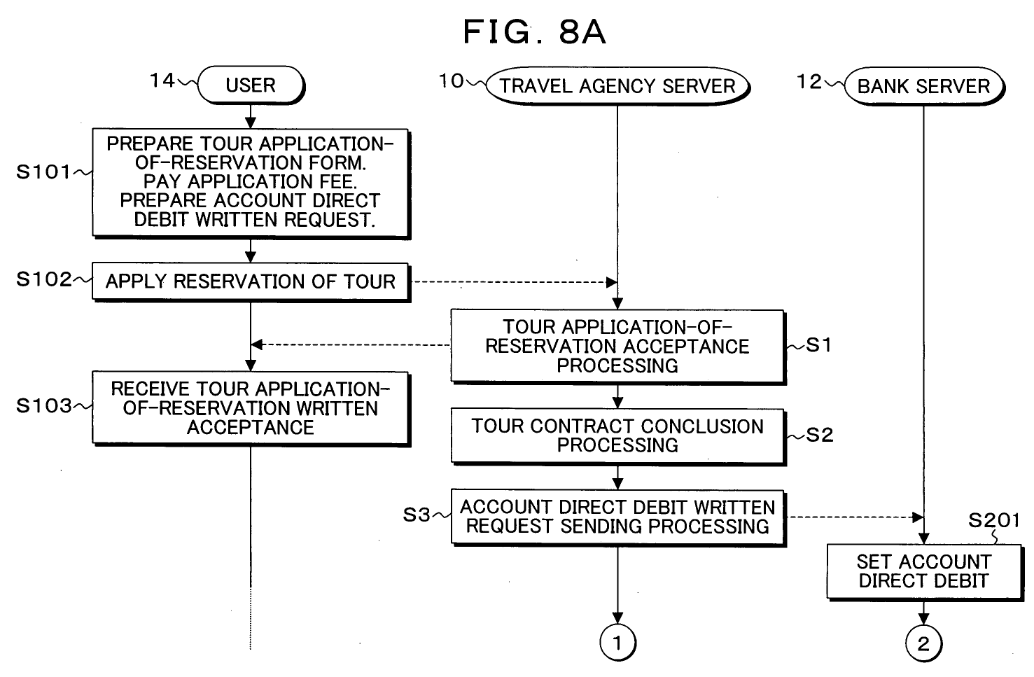

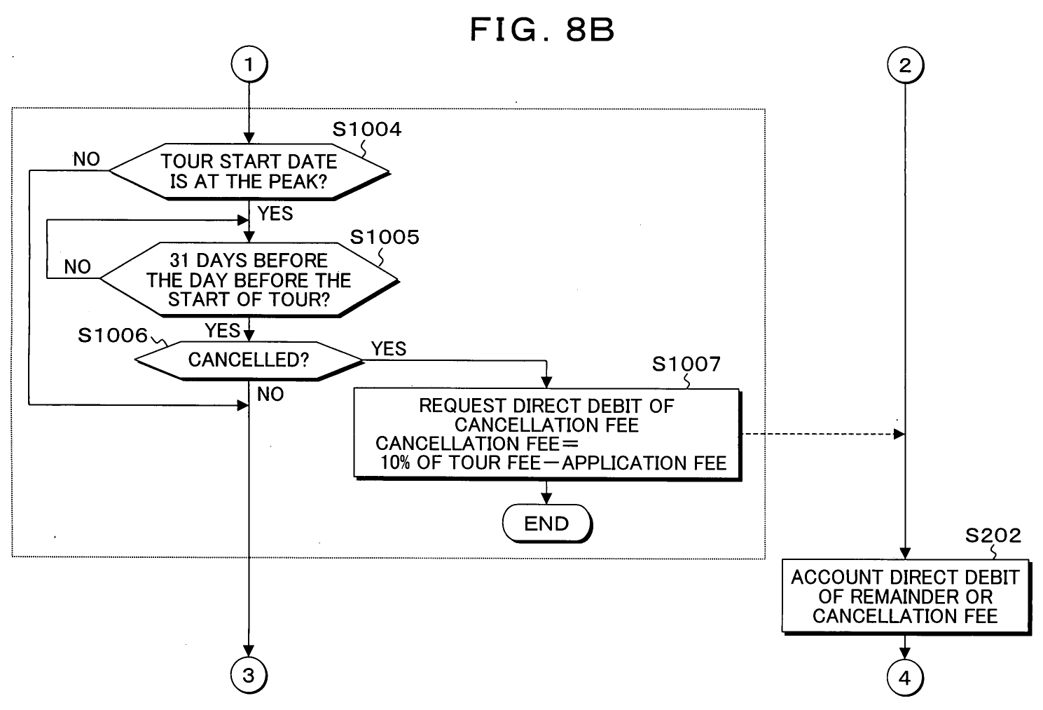

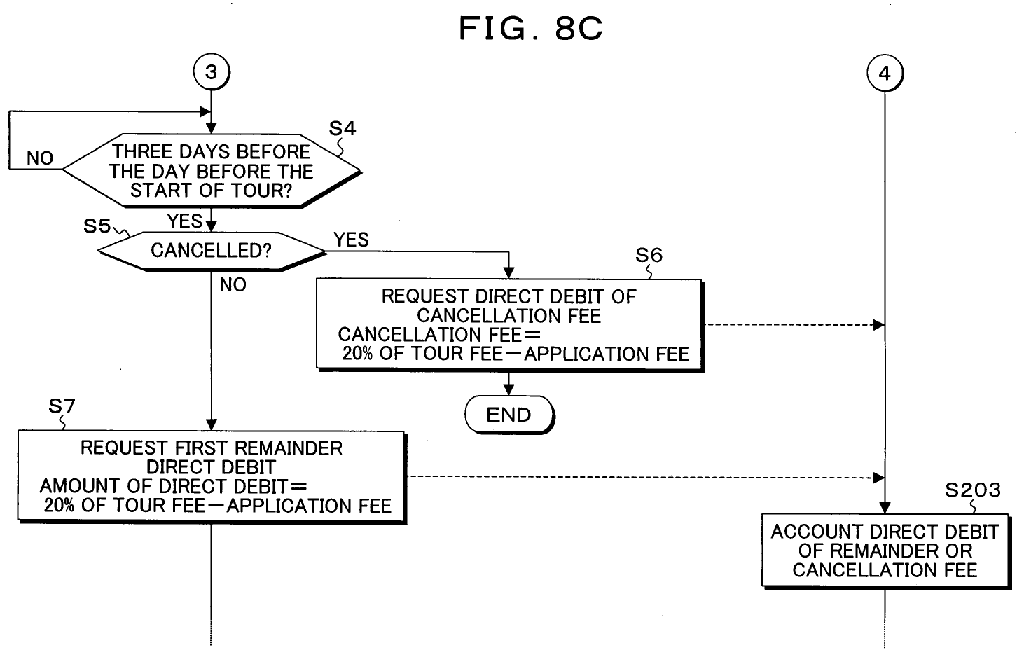

After the completion of the second balance direct debit request at step S11, the procedure goes to step S12 of FIG. 8 to check whether that day of the tour starting date has been reached. If no cancellation is accepted at step S13, then the procedure goes to step S15 in which the bank server 12 is requested for the third balance direct debit.

The direct debit amount in this case is the amount that remains after the application fee and the first and second direct debit amounts are deducted from 50% of the tour charge. In the example of the application of reservation of FIGS. 6A and 6B, 50% of the tour charge ¥250,000 per person is ¥125,000, totaling to ¥500,000 for four persons.

When the application fee of ¥200,000, the first direct debit amount of 0 yen and the second direct debit amount of ¥100,000 are deducted from the total cancellation fee of ¥500,000, the balance results in ¥200,000. Thus, the bank server 12 is requested for the direct debit of ¥200,000 as the third balance direct debit amount request, to perform the direct debit at step S204.

On the contrary, when an application of cancellation is issued from the user at step S13, the bank server 12 is requested for the cancellation fee direct debit at step S14. The cancellation fee in this case is the amount that remains after the application fee is deducted from 50% of the tour charge.

In the example of the application of reservation of FIGS. 6A and 6B, 50% of the tour charge per person is ¥125,000, totaling to ¥500,000 for four persons. Since the application fee of ¥200,000 is received in advance, the balance of the cancellation fee is ¥300,000, of which direct debit is requested of the bank server 12. The bank server 12 performs the direct debit of the cancellation fee balance requested at step S204.

When the third balance direct debit request is issued at step S15, the procedure goes to the next step S16 to check whether the user participates in the tour on the tour starting date. If affirmative, i.e., the participation of the user in the tour is established, then the procedure goes to step S18 to make the fourth balance direct debit request.

The direct debit amount in this case is the amount that remains after the already paid application fee, the fist to third direct debit amounts are deducted from 100% of the tour charge. The bank sever 12 is requested for the direct debit of the above direct debit amount, to perform the direct debit of the balance at step S205.

In the example of the application of reservation of FIGS. 6A and 6B, 100% of the tour charge per person is ¥250,000, totaling to ¥1,000,000. Since a total of ¥500,000 is already paid as the application fee, and the second and third direct debits excepting the first direct debit, the balance is ¥500,000, of which direct debit is requested of the bank server 12, to allow the direct debit at step S205.

On the contrary, at step S16, when the absence has been established of the user on that day of the tour starting date without no contact or when the travel agency has been informed of the cancellation after the start of the tour, the procedure goes to step S17 to send a cancellation fee direct debit request to the bank server 12.

The cancellation fee in this case is 100% of the tour charge and the bank server 12 is requested to make a direct debit of the cancellation fee which is the balance that remains after the application fee is deducted from the 100% of the tour charge. In the example of the application of reservation of FIGS. 6A and 6B, 100% of the tour charge per person is ¥250,000 totaling to ¥1,000,000 for four persons. When the application fee of ¥200,000 is deducted from ¥1,000,000, the balance of the cancellation fee is ¥800,000. The bank server 12 is requested to make a direct debit of the cancellation fee balance of ¥800,000 so that the cancellation fee can automatically be withdrawn from the user's account at step S205.

FIGS. 8A to 8C are flowcharts showing another embodiment of the application-of-reservation management processing effected in the travel agency server 10 of the present invention. This embodiment takes by way of example the case where the cancellation fee occurs as a result of cancellation of a tour whose tour starting date is at the peak.

In FIGS. 8A to 8C, the processings of steps S1 to S3 and the processings of step S4 and subsequent steps in the travel agency server 10 are substantially the same as those of the embodiment of FIGS. 7A to 7D. Newly added thereto are processings of steps S1004 to S1007 enclosed by a broken line for processing the cancellation at the peak.

In this processing at the peak, it is checked at step S1004 that the tour starting date is at the peak or not. If the tour starting date is at the previously defined peak, then the procedure goes to step S1005 to check whether the cancellation date is on 31 days prior to the day before the tour starting date.

If affirmative, then the procedure goes to step S1006 to check whether the cancellation is present or not. If the application of cancellation is issued from the user, then the bank server 12 is requested to make a cancellation fee direct debit at step S1007. The cancellation fee in this case is 10% of the tour charge and is the balance that remains after the application fee is deducted from the 10% of the tour charge.

In the example of application of reservation of FIGS. 6A and 6B, 10% of the tour charge per person is ¥25,000 totaling to ¥100,000 for four persons. Since the application fee of ¥200,000 is received in advance, the balance from the cancellation fee results in ¥100,000.

For this reason, the travel agency server 10 requests of the bank server 12 a transfer into the user's account the refund of ¥100,000 that remains after the cancellation fee is deducted from the application fee. At step S2002, the bank server 12 executes the direct debit of the cancellation fee requested, in this example, transfers the refund of ¥100,000 to the user's account that remains after the cancellation fee is deducted from the application fee.

In the above embodiments, for the application of reservation of a tour, the cancellation period up to the tour starting date is basically divided into four stages, and the balances of the tour charge are calculated based on the cancellation fee rates corresponding to the four states so that the tour charge balances are automatically withdrawn from the user's account in plural installations. However, the cancellation periods and the cancellation fees can appropriately be defined by the travel agency without deviating from legal standards. It is to be therefore appreciated that the cancellation fee rates or the amounts based on which the tour charges are calculated in the above embodiments are mere an example, and that the present invention is not limited by those numerical values.

The present invention includes any appropriate variants without impairing its objects and advantages. Although the above embodiments have taken the application of reservation of tours by way of example, the present invention is intactly applicable to any applications of reservation as long as the application of reservation can be accepted and thereafter be implemented as a service on the final day.

As set forth hereinabove, the present invention enables the user who has made an application-of-reservation of a tour to enjoy deferring the payment of a charge for the tour until a fixed date as closer to the tour starting date as possible and having enough time to prepare the payment of the charge for the tour, during which the user can benefit in terms of interest through operations of user's assets.

On the other hand, when the user's cancellation is confirmed by the travel agency during the cancellation periods set in a plurality of stages, the travel agency can automatically withdraw from the user's account the amount that remains after an application fee is deducted from a cancellation fee so that it can securely receive the cancellation fee without failing to collect the cancellation fee in case the user has made a cancellation.

What is claimed is:

1. An application-of-reservation management method comprising:
an application acceptance step accepting by an application accepting unit tour application-of-reservation information which includes application fee payment information and charge direct debit request information; and
a charge processing step calculating by a charge processing unit a tour charge direct debit amount based on a cancellation fee rate previously defined for each cancellation period if no application of cancellation is accepted during cancellation periods set in a plurality of stages taking as reference the tour starting date, and requesting a financial institution to make a direct debit of the tour charge direct debit amount from the applicant's account.

2. The application-of-reservation management method according to claim 1, further comprising:
a cancellation fee processing step calculating by a cancellation fee processing unit a cancellation fee based on the previously defined cancellation fee rate if an application of cancellation is accepted during any one of the cancellation periods set in a plurality of stages taking as reference the tour starting date, and requesting the financial institution to make a direct debit of the cancellation fee from the applicant's account.

3. The application-of-reservation management method according to claim 1, wherein the charge processing step comprises:
a first charge processing step, on three days prior to the day before the tour starting date, calculating a first direct debit amount that remains after the application fee is deducted from 20% of the tour charge, and requesting the financial institution to make a direct debit of the cancellation fee;
a second charge processing step, on the day before the tour starting date, calculating a second direct debit amount that remains after the application fee and the first direct debit amount are deducted from 30% of the tour charge, and requesting the financial institution to make a direct debit of the cancellation fee;
a third charge processing step, on that day of the tour starting date, calculating a third direct debit amount that remains after the application fee, the first direct debit amount and the second direct debit amount are deducted from 50% of the tour charge, and requesting the financial institution to make a direct debit of the cancellation fee; and
a fourth charge processing step, when the participation has been established after the start of the tour, calculating a fourth direct debit amount that remains after the application fee, the first direct debit amount, the second direct debit amount and the third direct debit amount are deducted from the tour charge, and requesting the financial institution to make a direct debit of the cancellation fee.

4. The application-of-reservation management method according to claim 2, wherein the cancellation fee processing step comprises:
a first cancellation processing step, when an application of cancellation has been accepted during a period from thirty days prior to the day before the tour starting date to three days before the tour starting date, calculating a cancellation fee that remains after the application fee is deducted from any one of ¥50,000 for the tour charge of ¥300,000 or more, ¥30,000 for the tour charge of ¥150,000 or more and less than ¥300,000, ¥20,000 for the tour charge of ¥100,000 or more and less than ¥150,000 and 20% of the tour charge for the tour charge of less than ¥100,000, and requesting the financial institution to make a direct debit of the cancellation fee;
a second cancellation processing step, when an application of cancellation has been accepted on two days before the tour starting date and on the day before the tour starting date, calculating a cancellation fee that remains after the application fee is deducted from 30% of the tour charge, and requesting the financial institution to make a direct debit of the cancellation fee;
a third cancellation processing step, when an application of cancellation has been accepted on that day of the tour staring date, calculating a cancellation fee that remains after the application fee is deducted from 50% of the tour charge, and requesting the financial institution to make a direct debit of the cancellation fee; and
a fourth cancellation processing step, when a participant has not appeared on the tour starting date without a contact or when an application of cancellation has bee accepted after the start of the tour, calculating a cancellation fee that remains after the application fee is deducted from 100% of the tour charge, and requesting the financial institution to make a direct debit of the cancellation fee.

5. The application-of-reservation management method according to claim 4, wherein
the cancellation fee processing step further comprises:
a peak cancellation processing step, when the tour starting date is at the peak and when an application of cancellation has been accepted during a period from 40 days prior to the day before the tour starting date to 31 days prior to the day before the tour starting date, calculating a cancellation fee that remains after the application fee is deducted from 20% of the tour charge with the cancellation fee's upper limit set to ¥50.000, the peck cancellation processing step, if the cancellation fee is positive, requesting the financial institution to make a direct debit of the cancellation fee, and if the cancellation fee is negative, requesting the financial institution to pay the shortage into the travel agency's account.

6. The application-of-reservation management method according to claim 5, wherein the peak is from December 20 to January 7, from April 27 to May 6, and from July 20 to August 31.

7. A program allowing a computer to execute:
an application acceptance step accepting tour application-of-reservation information which includes application fee payment information and charge direct debit request information; and
a charge processing step calculating a tour charge direct debit amount based on a cancellation fee rate previously defined for each cancellation period if no application of cancellation is accepted during cancellation periods set in a plurality of stages taking as reference the tour starting date, and requesting a financial institution to make a direct debit of the tour charge direct debit amount from the applicant's account.

8. The program according to claim 7, allowing the computer to further execute:
a cancellation fee processing step calculating a cancellation fee based on the previously defined cancellation fee rate if an application of cancellation is accepted during any one of the cancellation periods set in a plurality of stages taking as reference the tour starting date, and requesting the financial institution to make a direct debit of the cancellation fee from the applicant's account.

9. An application-of-reservation managing apparatus comprising:
an application accepting unit accepting tour application-of-reservation information which includes application fee payment information and charge direct debit request information; and
a charge processing unit calculating a tour charge direct debit amount based on a cancellation fee rate previously defined for each cancellation period if no application of cancellation is accepted during cancellation periods set in a plurality of stages taking as reference the tour starting date, and requesting a financial institution to make a direct debit of the tour charge direct debit amount from the applicant's account.

10. The application-of-reservation managing apparatus according to claim 9, further comprising:
a cancellation fee processing unit calculating a cancellation fee based on the previously defined cancellation fee rate if an application of cancellation is accepted during any one of the cancellation periods set in a plurality of stages taking as reference the tour starting date, and requesting the financial institution to make a direct debit of the cancellation fee from the applicant's account.

11. An application-of-reservation management method comprising:
an application acceptance step accepting by an application accepting unit an application-of-reservation which includes payment of an application fee and a request for direct debit of a charge from the applicant's account; and
a charge processing step calculating by a charge processing unit a charge direct debit amount based on a cancellation fee rate previously defined for each cancellation period if no application of cancellation is accepted during cancellation periods set in a plurality of stages taking as reference the execution date of the reservation applied, and requesting a financial institution to make a direct debit of the charge direct debit amount from the applicant's account.

12. The application-of-reservation management method according to claim 11, further comprising:
a cancellation fee processing step calculating by a cancellation fee processing unit a cancellation fee based on the previously defined cancellation fee rate if an application of cancellation is accepted during any one of the cancellation periods set in a plurality of stages taking as reference the execution date of the reservation applied, and requesting the financial institution to make a direct debit of the cancellation fee from the applicant's account.
